(19) United States
(12) Patent Application Publication
(10) Pub. No.: US 2007/0181387 A1
(43) Pub. Date: Aug. 9, 2007

(54) Brake assembly, brake actuator and method of making a brake actuator

(75) Inventors: Kenneth E. Scheckelhoff, Elyria, OH (US); Ronald S. Plantan, Westlake, OH (US)

Correspondence Address: CROWELL & MORING LLP;INTELLECTUAL PROPERTY GROUP, P.O. BOX 14300, WASHINGTON, DC, 20044-4300, US

(73) Assignee: Bendix Commercial Vehicle Systems, LLC., Elyria, OH (US)

(21) Appl. No.: 11/347,389

(22) Filed: Feb. 6, 2006

(51) Int. Cl. F16D 55/02

(52) U.S. Cl. 188/71.7

(57) ABSTRACT

A brake assembly includes a brake, an actuator, and an automatic slack adjuster for adjusting the clearance between the brake shoes and the brake drum. The actuator includes a housing, a piston moveably disposed in the housing, a yoke disposed outside of the housing, and a pushrod extending through the housing. The pushrod is connected to the piston, and an end portion of the pushrod forms a rivet that attaches the yoke to the end portion of the pushrod.

### FIELD OF THE INVENTION

This invention relates to a brake assembly, a brake actuator, and a method of making a brake actuator.

### BACKGROUND OF THE INVENTION

Various types of brakes are provided for motor vehicles. For example, airbrakes are typically provided for heavy vehicles. An actuator for an airbrake typically includes a housing defining an air chamber, a piston moveably disposed in the housing, and a pushrod connected to the piston. The pushrod extends to the outside of the housing, and the end of the pushrod outside of the housing is connected to a yoke. An example is described in U.S. Pat. No. 6,253,890.

The yoke is connected to a cam via a linkage. When the air chamber is supplied with compressed air, the piston/pushrod/yoke assembly extends from the chamber and rotates the cam to push brake shoes into contact with a brake drum. When the compressed air is vented from the chamber, the piston/pushrod/yoke assembly retracts into the air chamber and the cam is rotated in a reverse direction so that the brake shoes move clear of the brake drum. Ideally, an optimal clearance is provided between the brake shoes and the brake drum when the brakes are released. This clearance should be uniform for all brakes so that uniform braking forces are applied to the wheels on both sides of the vehicle. The clearance should also be small so that the piston/pushrod/yoke assembly extending from the air chamber need move only a small distance to engage the brakes. However, sufficient clearance must be provided to prevent the brake shoes from dragging on the drum, even when they are hot and experiencing thermal expansion.

An automatic slack adjuster is used to adjust the clearance between the brake shoes and the brake drum when the brake is released. A typical automatic slack adjuster includes a worm gear which is keyed or connected via splines to the cam shaft which moves the brake shoes. A worm shaft mounted to rotate about an axis perpendicular to the cam axis engages the worm gear for establishing the angular position between a housing for the slack adjuster and the cam shaft. A device is provided for rotating the worm gear to automatically change the angular position between the slack adjuster housing and the cam shaft for eliminating slack as the brake shoes become worn. The device includes a toothed conical clutch that can be used to disconnect the adjusting mechanism during the elasticity part of the brake application so as to obtain a slack adjusting function. During the adjustment, which typically occurs at brake release, the clutch is engaged and transmits an angular movement and a torque to effect slack adjustment. A typical automatic slack adjuster is described in U.S. Pat. No. 5,350,043, the disclosure of which is hereby incorporated by reference.

For the automatic slack adjuster to operate properly, the pushrod must be within a certain range of length. In various vehicle configurations, the pushrods of different lengths are used to ensure proper operation of the automatic slack adjuster. The yoke then is permanently attached to an end of the pushrod. Typically, the yoke is permanently attached to the pushrod using welding.

However, welding of the yoke to the pushrod has several disadvantages. For example, welding equipment is relatively expensive. And the heat generating by welding may weaken the yoke or the pushrod.

### SUMMARY OF THE INVENTION

In accordance with one aspect of the invention, a brake assembly includes a brake, an actuator, and an automatic slack adjuster for adjusting the clearance between the brake shoes and the brake drum. The actuator includes a housing, a piston moveably disposed in the housing, a yoke disposed outside of the housing, and a pushrod extending through the housing. The pushrod is connected to the piston, and an end portion of the pushrod forms a rivet that attaches the yoke to the pushrod.

In accordance with another aspect of the invention, a brake actuator includes a housing, a piston moveably disposed in the housing, a yoke disposed outside of the housing, and a pushrod extending through the housing. The pushrod is connected to the piston, and an end portion of the pushrod forms a rivet that attaches the yoke to the pushrod.

Preferably, the yoke includes a through hole, and the pushrod extends through the through hole of the yoke. The end of the pushrod may be radially greater than the through hole to prevent the yoke from sliding off the end portion of the pushrod. The end portion of the pushrod can include an indentation.

In a preferred embodiment, the end portion of the pushrod is radially smaller than the rest of the pushrod. For example, the end portion of the pushrod may have a first diameter, and the rest of the pushrod has a second diameter that is greater than the first diameter. The through hole can be radially greater than the end portion of the pushrod but radially smaller than the rest of the pushrod. For example, the through hole can have a third diameter that is greater than the first diameter but smaller than the second diameter. As a result, the yoke can be mounted on the end portion of the pushrod but cannot be mounted on the rest of the pushrod. When the yoke is mounted on the end portion of the pushrod, it may rest against an end of the rest of the pushrod, which end forms the interface between the end portion of the pushrod and the rest of the pushrod.

In accordance with a further aspect of the invention, a method of making a brake actuator includes extending an end portion of a pushrod of the brake actuator through a through hole of a yoke of the brake actuator, and radially extending the end of the pushrod to a size that is radially greater than the through hole to prevent the yoke from sliding off the end portion of the pushrod. The method may further include providing an indentation on the end portion of the pushrod.

The present invention has various advantages. For example, when compared with welding equipment, riveting equipment is less expensive. Additionally, riveting does not weaken the yoke or the pushrod.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates a brake actuator in accordance with an embodiment of the present invention.

FIG. 2 is a partial cross-sectional view of a rivet connection between the pushrod and the yoke of the brake actuator shown in FIG. 1.

FIGS. 3a and 3b are before-and-after partial cross section views illustrating assembly of the rivet connection between the pushrod and the yoke of the brake actuator shown in FIG. 1.

### DETAILED DESCRIPTION OF THE PREFERRED EMBODIMENTS

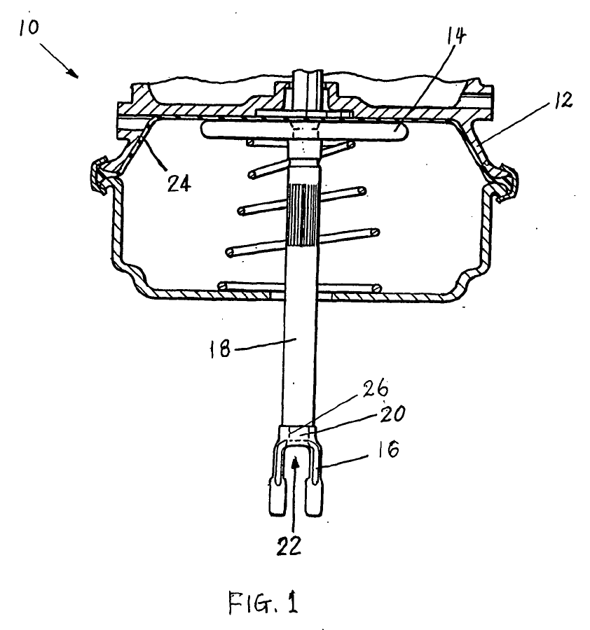

FIG. 1 illustrates a preferred brake actuator 10 of the present invention. The rest of the brake assembly is not specifically illustrated here, because examples are described by and shown in U.S. Pat. Nos. 5,350,043 and 6,253,890, both of which are incorporated herein by reference.

The brake actuator 10 includes a housing 12, a piston 14 moveably disposed in the housing 12, a yoke 16 disposed outside of the housing 12, and a pushrod 18 extending through the housing 12. The pushrod 18 is connected to the piston 14, and an end portion 20 of the pushrod 18 forms a rivet 22 that attaches the yoke 16 to the pushrod 18.

The housing 12 may have any suitable configuration, although it typically has a generally hollow cylindrical configuration. The piston 14, typically configured as a cylinder or a disk plate, may be placed in the housing 12 so that it can move in the axial direction in the housing 12. Preferably, a seal 24 is provided between the housing 12 and the piston 14. The seal may be a sealing ring or a sealing membrane. The pushrod 18 has a generally elongated configuration. The cross-section of pushrod 18 may have any suitable shape, such as a circle, a triangle, or a square. The yoke 16 has the general configuration of a fork but can be configured in any manner that allows it to connect the piston-pushrod assembly to the rest of the brake assembly.

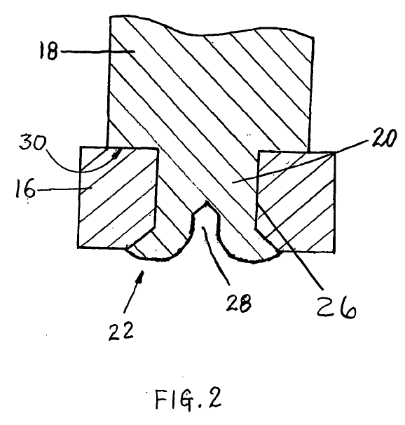

As illustrated in FIG. 2, the yoke 16 preferably includes a through hole 26, and the pushrod 18 extends through the through hole 26 of the yoke 16 to attach the pushrod 18 to the yoke 16. The end portion 20 of the pushrod 18 may be radially greater than the through hole 26 to form the rivet 22, preventing the yoke 16 from sliding off the end portion 20 of the pushrod 18. The end portion 20 of the pushrod 18 can include an indentation 28. The indentation 28 makes it easier to deform the end portion 20 of the pushrod 18 to make it radially greater than the through hole 26 to form the rivet 22.

In a preferred embodiment, the end portion 20 of the pushrod 18 is radially smaller than the rest of the pushrod 18. For example, the end portion 20 of the pushrod 18 may have a first diameter, and the rest of the pushrod 18 has a second diameter that is greater than the first diameter. The through hole 26 can be radially greater than the end portion 20 of the pushrod 18 but radially smaller than the rest of the pushrod 18. For example, the through hole 26 can have a third diameter that is greater than the first diameter but smaller than the second diameter. As a result, the yoke 16 can be mounted on the end portion 20 of the pushrod 18 but cannot be mounted on the rest of the pushrod 18. When the yoke 16 is mounted on the end portion 20 of the pushrod 18, it may rest against an end 30 of the rest of the pushrod 18, which end 30 forms the interface between the end portion 20 of the pushrod 18 and the rest of the pushrod 18.

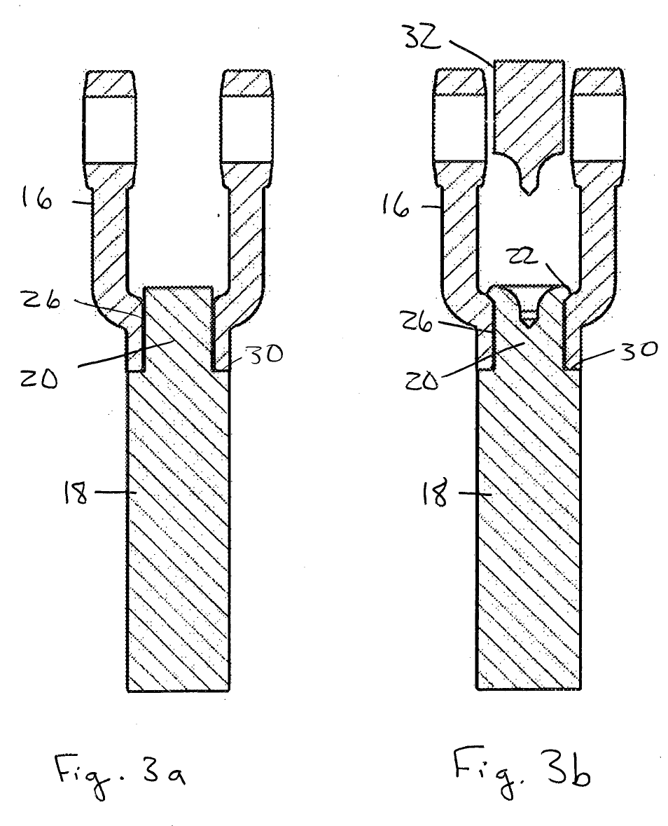

In accordance with a further aspect of the invention, a method of making a brake actuator includes first extending an end portion 20 of a pushrod 18 of the brake actuator through a through hole 26 of a yoke 16 of the brake actuator, as shown in FIG. 3a (the indentation 28 shown in FIG. 2 is not included in this figure). Once end portion 20 is fully seated in hole 26, the end portion 20 is radially expanded to a size that is radially greater than the through hole 26 to prevent the yoke 16 from sliding off the end portion 20 of the pushrod 18, as shown in FIG. 3b. This expansion may be generated, for example, but pressing a flaring tool 32 into the exposed end of end portion 20 in order to form the yoke-retaining rivet 22 shown in FIG. 3b. Preferably, the tool is pressed into end portion 22 by an impact technique, as traditional rivet-forming processes such as spin-riveting may be inhibited by the close proximity of the legs of the fork of the yoke. Because the brake application forces, which are typically on the order of 200-400 pounds, are carried by the end 30, and the brake actuator return forces are much lower (typically on the order of 60 pounds), the pushrod-yoke joint formed in this manner is sufficient to sustain the typical in-service range of brake actuation forces.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A brake assembly comprising:
a brake;
an actuator including
a housing,
a piston moveably disposed in the housing,
a yoke disposed outside of the housing, and
a pushrod extending through the housing and including an end portion, wherein the pushrod is connected to the piston, and wherein the end portion of the pushrod forms a rivet that attaches the yoke to the end portion of the pushrod; and
an automatic slack adjuster.

2. The brake assembly of claim 1, wherein the yoke includes a through hole, and the pushrod extends through the through hole of the yoke, and wherein the end of the pushrod is radially greater than the through hole to prevent the yoke from sliding off the end portion of the pushrod.

3. The brake assembly of claim 2, wherein the end portion of the pushrod includes an indentation.

4. The brake assembly of claim 2, wherein the end portion of the pushrod is radially smaller than the rest of the pushrod, and wherein the through hole is radially greater than the end portion of the pushrod but radially smaller than the rest of the pushrod.

5. The brake assembly of claim 4, wherein the end portion of the pushrod has a first diameter and the rest of the pushrod has a second diameter that is greater than the first diameter, and wherein the through hole has a third diameter that is smaller than the second diameter.

6. The brake assembly of claim 5, wherein the yoke rests against an end of the rest of the pushrod.

7. The brake assembly of claim 4, wherein the yoke rests against an end of the rest of the pushrod.

8. A brake actuator comprising:
a housing,
a piston moveably disposed in the housing;
a yoke disposed outside of the housing; and
a pushrod extending through the housing and including an end portion, wherein the pushrod is connected to the piston, and wherein the end portion of the pushrod forms a rivet that attaches the yoke to the end portion of the pushrod.

9. The brake actuator of claim 8, wherein the yoke includes a through hole, and the pushrod extends through the through hole of the yoke, and wherein the end of the pushrod is radially greater than the through hole to prevent the yoke from sliding off the end portion of the pushrod.

10. The brake actuator of claim 9, wherein the end portion of the pushrod includes an indentation.

11. The brake assembly of claim 9, wherein the end portion of the pushrod is radially smaller than the rest of the pushrod, and wherein the through hole is radially greater than the end portion of the pushrod but radially smaller than the rest of the pushrod.

12. The brake assembly of claim 11, wherein the end portion of the pushrod has a first diameter and the rest of the pushrod has a second diameter that is greater than the first diameter, and wherein the through hole has a third diameter that is smaller than the second diameter.

13. The brake assembly of claim 10, wherein the yoke rests against an end of the rest of the pushrod.

14. The brake assembly of claim 11, wherein the yoke rests against an end of the rest of the pushrod.

15. A method of making a brake actuator, comprising:
extending an end portion of a pushrod of the brake actuator through a through hole of a yoke of the brake actuator; and
radially extending the end of the pushrod to a size that is radially greater than the through hole to prevent the yoke from sliding off the end portion of the pushrod.

16. The method of claim 15, further including providing an indentation on the end portion of the pushrod.
